(19) United States
(12) Patent Application Publication
(10) Pub. No.: US 2004/0041354 A1
(43) Pub. Date: Mar. 4, 2004

(54) Sealing device

(76) Inventor: Andreas Derr, Wutoeschingen (DE)

Correspondence Address: Choate Hall & Stewart, Patent Group, Exchange Place, 53 State Street, Boston, MA, 02109-2804, US

(21) Appl. No.: 10/450,329

(22) PCT Filed: Nov. 30, 2001
(86) PCT No.: PCT/EP01/14032

(30) Foreign Application Priority Data
Dec. 12, 2000 (DE) 100 61 885.5

(51) Int. Cl. F16J 15/46

(52) U.S. Cl. 277/628

(57) ABSTRACT

The invention relates to a sealing device for sealing a housing comprising a first housing element having at least one groove, and a second housing element having at least one segment. Said segment and said groove engage with each other in the closed state of the housing, forming a sealing gap. The inventive sealing device also comprises a sealing element which can be introduced into the sealing gap, and elastically compressed, essentially vertically in relation to the direction of the joint, when the segment is inserted into the groove.

The present invention relates to a sealing device according to the preamble of Patent claim 1, i.e., a sealing device for sealing a housing, comprising a first housing element having at least one groove and a second housing element having at least one web, the web and groove engaging to form a sealing gap when the housing is in a closed state.

Sealing devices are differentiated essentially into radial seals and surface seals. These known sealing devices are described briefly below.

In the case of radial seals, the sealing effect is produced by the compression or pressing of an elastic O-ring, which is mounted in a corresponding groove on a cover, for example, and engages in an inside surface of a bottom housing part after the cover has been-placed in position. The restoring force of the O-ring on the adjacent inside surface of the housing results in a sealing force which to some extent prevents external media such as water, moisture, dust, bacterial contaminants and the like from penetrating into the interior of the housing.

Since the sealing forces which act radially are usually perpendicular to the direction of joining, i.e., to the direction of closing of the cover, there is no force vector against the direction of joining when the seal is stationary, so that there is also no tendency toward opening, and therefore no opening force acts on the cover relative to the housing part.

The sealing forces acting on the bottom housing part and/or on the cover or the top housing part are distributed uniformly over the circumference of the housing and are almost equal in absolute value. However, these relatively great sealing forces must be absorbed by the housing, and the resulting stresses in the housing, i.e., in both the top housing part and in the cover, must not result in deformation of the housing and thus to a diminished sealing effect.

However, these stresses are especially critical in the case of housing walls which are relatively thin and mostly straight, and in the case of large housing diameters, in which case the housing wall may yield slightly at some points, so that the sealing device loses its sealing effect and the housing becomes leaky.

Mostly packing cords or O-rings having a small cross section are used as the sealing material on such housings where high demands are made that they be leakproof, e.g., in the case of manual measuring instruments. In addition, for stability reasons, the amount of pressure and thus the resulting sealing force of the housing walls, which are often made of plastic, must not be particularly high. It follows from this that the desired sealing forces in the case of plastic are implementable only through compression paths on the order of 0.1 to 0.2 mm. However, this presupposes that the manufacturing tolerances for the housing parts are kept very small, in particular in the area of the sealing device, and do not exceed the absolute value of the compression, i.e., the compression path. Due to the manufacturing method, with some housing parts this is not always possible and to some extent is even impossible.

Another problem with radial seals occurs due to frictional forces. Since the joining direction and the direction of the sealing force are offset by 90° to one another, the result in joining or insertion is a frictional force which counteracts the joining force and thus makes joining more difficult.

Furthermore, due to the elasticity and the rolling of a packing cord, complete closing of the housing to the final position is not always possible, resulting in undesirably contaminated joints. Furthermore, there may be a resulting force which acts against the joining direction and in the direction of opening of the cover.

Furthermore, for the installation of the O-ring and/or the packing cord, these must preferably be inserted into a groove provided specifically for that purpose in a housing part. However, this is possible only if the top part has contours onto which the O-ring may be forced or into which it may be inserted. If the housing part also has other recesses in addition to these contours, then the O-ring will not always sit correctly, so that proper functioning of the sealing device is no longer ensured.

For all the reasons given above, radial seals are unsuitable or only suitable under certain conditions for a majority of housings, e.g., for measuring instruments made of plastic, despite their good sealing effect and the lack of an opening force.

In the case of surface seals, which may be designed in the form of a ring or a rectangle, the sealing effect occurs due to the compression of an elastic ring, although in the case of a surface seal, the ring is placed in corresponding grooves on their contact faces between the top housing part and the bottom housing part. In the case of surface seals, the sealing forces act in the same direction as the joining direction, so that the same absolute force must be expended for the opening force as for the sealing force. For this reason, the top housing part and the bottom housing part are typically joined together by mechanical means, e.g., screws, snap hooks, etc.

Here again, sealing forces are generated by compression of the elastic material of the sealing ring. Therefore, these forces are relatively great. The sealing forces are also absorbed by the rigidity of the housing, but here again, deformation of the housing parts results in a reduction in the sealing effect.

Plastic housings in particular often have insufficient rigidity. Rigidity here is often achieved by a large number of screw points and/or snap hooks, although these greatly increase manufacturing costs. Furthermore, in the case of small housings in particular, a large number of screw points and/or snap hooks is frequently impossible for reasons of space.

Since the sealing forces and the joining forces have the same absolute value and act in the same direction, special assembly devices such as presses, screws and clamps are often needed for joining the parts. However, these assembly devices are awkward for the user because rapid opening and closing are often impossible. In addition, they are not suitable for frequent opening and closing operations.

Furthermore, the same problems occur with respect to the manufacturing tolerances with this type of seal as with the radial seals.

Although the use of packing cords as surface seals is suitable for complex sealing situations because such cords need only be inserted into an existing sealing groove, they have the disadvantage that they may fall out of the groove or be lifted out of the groove during assembly because of a lack of tension on the packing cord.

Therefore, despite the independence of the sealing operation, because of the lack of rigidity of the housing part, known surface seals are not suitable as seals for these parts, and they also result in leakage in some cases.

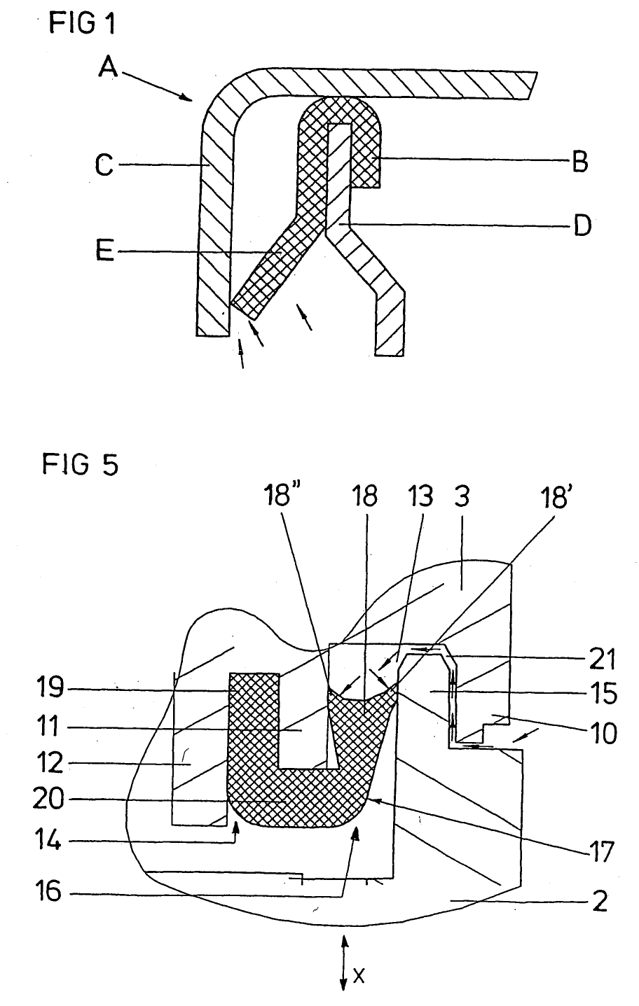

A sealing device of the type defined in the preamble is described, for example, in German Utility Model 1 773 961. FIG. 1 shows a sealing device which is described in German Utility Model 1 773 961.

In sealing device A, which is described in the above document, sealing element B is not compressed when two housing parts C, D are joined but instead is merely bent over. Therefore, to achieve a good sealing effect, a high precision of the outside contours of the two housing parts C, D as well as of sealing element B is an absolute requirement. In the case of larger housings in particular, it is increasingly more difficult with the above-mentioned sealing device to maintain this precision consistently. In addition, housing parts C, D must be designed to have the-greatest possible dimensional stability, i.e., there must be a high degree of rigidity between top housing part C and bottom housing part D. However, rigidity typically declines over time in the case of housing parts made of plastic, so this sealing device has only limited suitability for housings made of plastic. In particular in the case of deformation of parts of a housing, the risk of leakage is especially great here.

One sealing leg E of sealing element B is protected from lifting up from top housing part B only by the elasticity of the material, so the seal may lift up and thus lose its sealing effect, depending on the stress, e.g., due to water splashed or sprayed from a high-pressure cleaner (arrows).

In addition, German Utility Model 1 773 961 describes the use of a soft sealing material instead of a rigid sealing material. Since these soft sealing materials typically have a lower sealing effect than hard or rigid sealing materials, additional measures such as gluing are necessary.

Therefore, the object of the present invention is to improve upon a sealing device-of the type defined in the preamble which will ensure a very good sealing effect using simple technical means.

According to the present invention, this object is achieved by a sealing device according to claim 1. Accordingly, a sealing device of the type defined in the preamble is characterized in that at least one sealing element is provided, being shaped in such a manner that it is insertable into the sealing gap and is elastically compressible there essentially at a right angle to the joining direction when the web is inserted into the groove.

The idea on which the present invention is based is that in contrast with the known sealing devices, a form-fitting connection is achieved between the top housing part and the bottom housing part due to the alignment of one housing part relative to the other. The remaining inaccuracy is compensated by the special design of the sealing element. This permits a very good sealing effect over the area.

The sealing force has a very low absolute value in the case of the sealing device according to the present invention, because it is generated mostly by compression of the sealing element and/or its tips or edges and not exclusively by bending of same.

In addition, the sealing force need not be absorbed by the rigidity of the two housing parts but instead may be absorbed by the rigidity of just one housing part. In the present case, this is the housing part having the groove. The sealing force is especially high when smaller shapes are used. The housing parts themselves are joined together without tension. In addition, the joining force is also very low because of the low sealing force and thus the low resulting frictional force. The housing parts may be assembled to advantage by using the sealing devices according to the present invention.

According to the present invention, the sealing element has a first leg which is inclined outward at least with its outside surface, starting from its base, and may be brought to rest against a web of a housing part in the sealing gap in such a way that a sealing force that is essentially perpendicular to this housing part and/or to the particular outside surface of the web may be generated. According to the present invention, the free end of the first leg may be deformed by the joining movement. Due to this deformation, the material of the sealing element is compressed and then the sealing force is generated because of the restoring force of the material of the sealing element, which is typically designed to be elastic. It is especially advantageous that with the sealing device according to the present invention, the sealing force and the joining force are essentially perpendicular to one another, so there is a very low opening tendency of the bottom housing part relative to the top housing part.

In a first embodiment, the first leg has a conical taper toward its free end and forms a tip. In a second embodiment, the first leg is designed to be wedge shaped or triangle shaped toward its free end. This permits an additional significant reduction in the sealing force.

The sealing element advantageously has a contact part against which one or both housing parts is/are in contact with a sealing effect when the housing is closed. This makes it possible to generate an additional sealing force and thus achieve an improvement in the sealing effect. This sealing force is essentially parallel to the joining direction.

The bottom housing part and/or the top housing part need not necessarily be closed but instead may also vary within certain limits. The accuracy between the outside contours of the bottom housing part and the top housing part need not be identical within narrow limits. In particular, the contour of the housing part having the web need not be aligned with the contour of the groove. For example, the bottom housing part may be labile, and the top housing part may be designed to be rigid, with the top housing part calibrating the bottom housing part and thus securing it. A length of tubing may even be used as the labile bottom housing part.

In one embodiment, the sealing element has at least one additional leg. A housing part has an additional groove, which is used to accommodate the additional leg. It is especially advantageous with respect to the sealing effect and assembly if the sealing element is designed essentially with a U-shaped cross section to accommodate a projection on the housing part, and if its second leg is insertable into the other groove of this housing part with an accurate fit. In this way, the sealing element may be secured very well within the housing.

In addition, it is advantageous if the first leg is shorter in the stress-free condition than the second leg, because then no additional space need be made available in the housing part to accommodate the bent-over tip.

An especially simple cross-sectional shape, which is therefore also manufacturable at a very low cost, is obtained when the second leg and the base part are designed to have a rectangular cross section, while the first leg has a triangular, wedge-shaped, conical, or other similar design, as mentioned above.

The sealing element may advantageously be inserted completely into the housing when the housing is closed. However, it is also possible to insert the sealing element into the housing so that the outside surface of the second leg rests freely on one outside surface of the housing.

If the exposed outside surface of the second leg has rounded edges and the sealing element is insertable into the housing so that the exposed outside surface of the second leg projects above the outside surface of the housing, then the sealing element may additionally be used as a shock absorber for the housing.

The parts are secured and sealed relative to one another by the sealing element, which is typically designed to have a wedge shape and may be supported as a floating element so that it is installed in any desired manner in the groove between the bottom housing part and the top housing part.

The sealing material may be rigid or soft. However, the sealing material is advantageously composed at least in part of an elastic material. Typically a plastic is used here, in particular an elastomer or a natural rubber. Furthermore, it is possible to additionally provide the sealing element with reinforcing elements in order to provide a lower elasticity for certain application fields.

In the case of housings made of plastic, the rigidity and thus the tension on the housing wall typically decline over a period of time. In contrast with sealing devices according to the related art, the sealing device according to the present invention does not depend on a certain rigidity prevailing between the housing parts. Thus, the present invention permits a wide choice of materials.

Additional advantageous embodiments and refinements of the present invention are characterized in the subclaims and the description with reference to the drawing.

The present invention is explained in greater detail below on the basis of the exemplary embodiments characterized in the figures of the drawing.

FIG. 1 shows a cross section through a sealing device according to the related art;

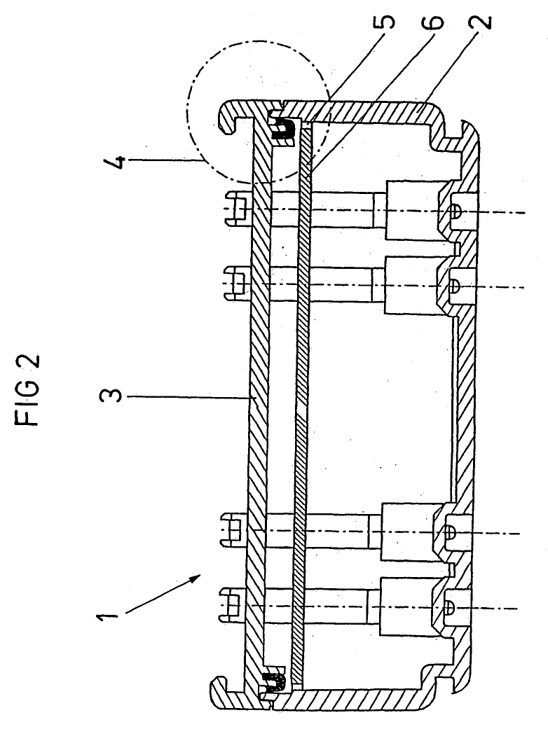

FIG. 2 shows a cross-sectional diagram of a housing having a sealing device according to the present invention;

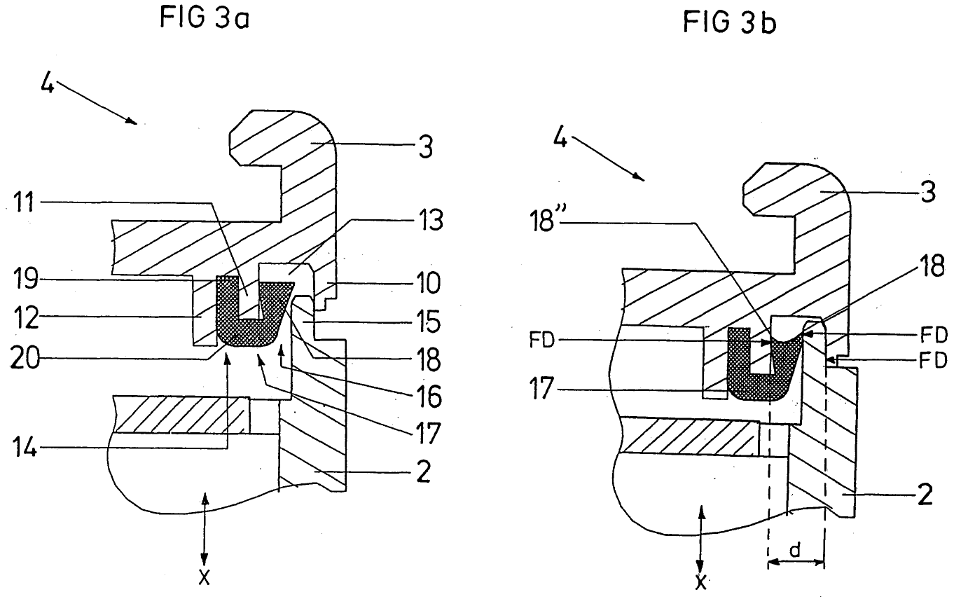

FIG. 3 shows an enlarged view of a first exemplary embodiment of the sealing device illustrated in FIG. 2 on insertion (a) and with the housing closed (b);

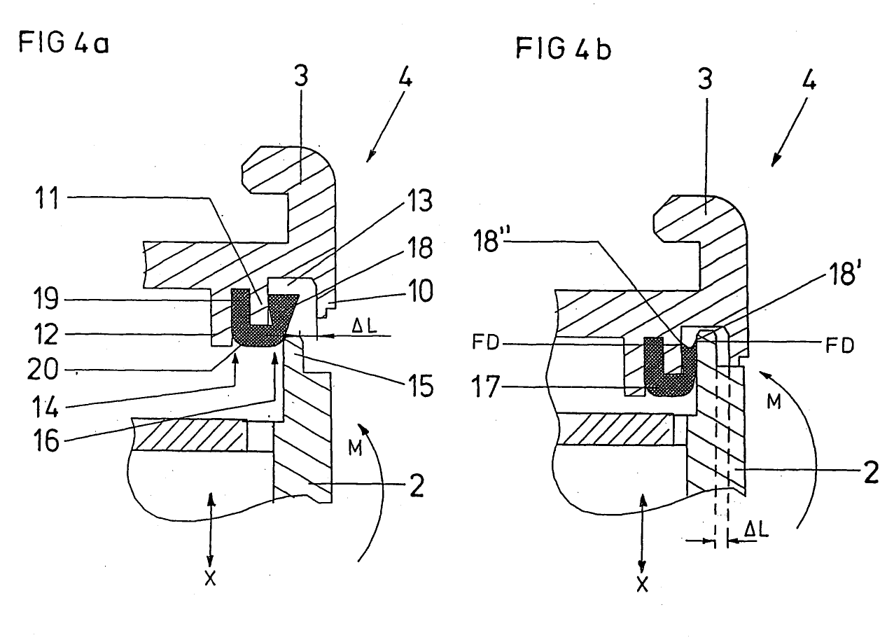

FIG. 4 shows an enlarged view of the sealing device illustrated in FIG. 2 with the housing deformed on insertion (a) and with the housing closed (b);

FIG. 5 shows an enlarged view of the sealing device illustrated in FIG. 2 having a gap between the housing parts;

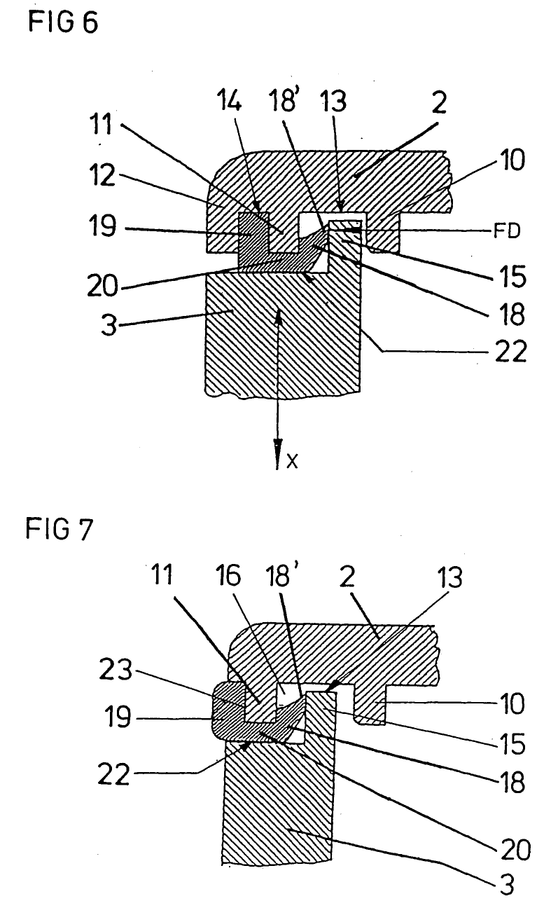

FIG. 6 shows a second exemplary embodiment of the sealing device according to the present invention;

FIG. 7 shows a third exemplary embodiment of the sealing device according to the present invention;

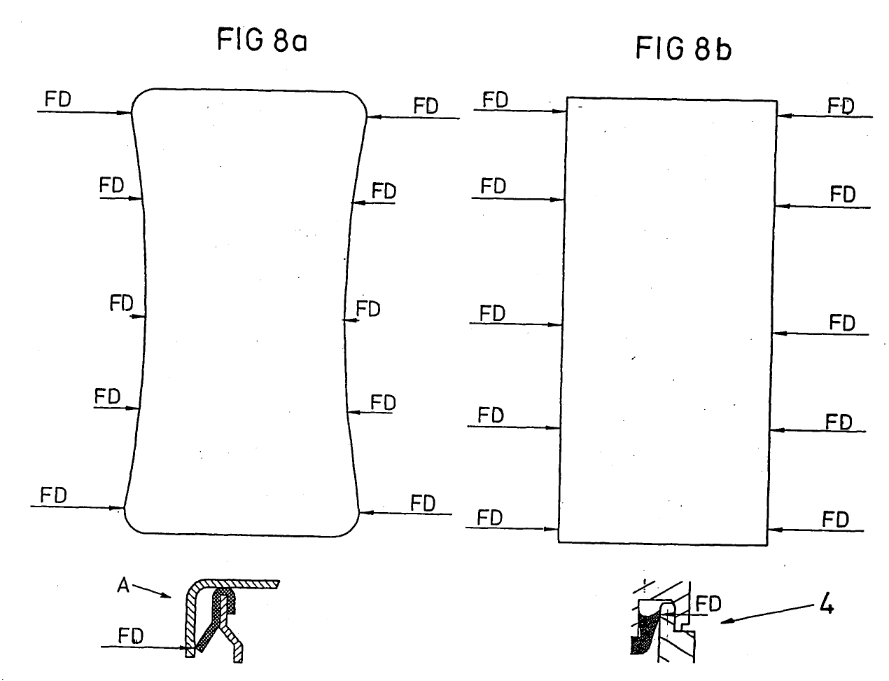

FIG. 8 schematically shows the distribution of the sealing forces FD in a rectangular housing having a sealing device according to the related art (b) and having a sealing device according to the present invention (b).

Unless otherwise indicated, the same elements and parts or those having the same function are labeled with the same reference numbers in the following figures.

FIG. 2 shows a cross sectional diagram of a housing having a sealing device according to the present invention.

FIG. 1 shows a housing 1, e.g., to accommodate a measuring instrument. Housing 1 is designed in two parts, i.e., it has a bottom housing part 2 and a top housing part 3. The two housing parts 2, 3 are joined together in a form-fitting manner by a sealing device 4, the design of which is described in greater detail on the basis of the following figures. In the present exemplary embodiment, housing part 2 is designed as the base body in which a measuring instrument may be embedded, while top housing part 3 is designed as an impact-resistant protective covering (cover) which protects the impact-sensitive parts of the measuring device. Bottom housing part 2 has a receptacle device 5 to accommodate a circuit board 6 of the measuring instrument.

FIGS. 3 through 5 each show an enlarged view of a first exemplary embodiment of the sealing device shown in the circle in FIG. 2, where (a) denotes sealing device 4 on insertion and (b) denotes sealing device 4 when housing 1 is closed. For the sake of simplicity, each individual subfigure has not been labeled completely.

According to FIG. 3, top housing part 3 has three projections 10, 11, 12 which extend in the direction of bottom housing part 2. Outer projection 10 and middle projection 11, which is also referred to as a spring, form a first groove 13, and middle projection 11 and inside projection 12 form a second groove 14. On a free side, bottom housing part 2 has a notched recess so that a web 15, which is flush with the inside of the housing and is referred to as a sealing spring, is present. Web 15 is insertable into first groove 13, the area between the inside surface of web 15 and the outside surface of middle projection 11 defining a free sealing gap 16.

Furthermore, FIG. 3 shows an at least partially elastic sealing element 13 designed to have an essentially U-shaped cross section. Sealing element 17 has a first leg 18, a second leg 19 and a base part 20 between them.

First leg 18 has a wedge-shaped or triangular cross section in the present exemplary embodiment, so that it tapers from its free end to base part 20. Second leg 19 and second groove 14 are designed at their free ends to engage mutually with a precision fit. U-shaped sealing element 17 is placed around metal projection 11 of housing part 3, so that when web 15 is guided into first groove 13, first leg 18 of sealing element 17 is guided into sealing gap 16. When housing 1 is closed, tips 18′, 18″ of wedge-shaped leg 18 come to rest against the particular surfaces of middle projection 11 and web 15 so that sealing element 17 is deformed.

Because of the restoring force of the elastic material of sealing element 17 and the resulting tendency to become deformed, i.e., to be bent back while also being compressed, the result is a sealing force FD. This sealing force FD has a relatively small absolute value because it is not produced exclusively by compression but instead is also formed largely by bending the tips of first leg 18.

In addition, when using this sealing element 17, almost no opening force is generated, so that top housing part 3 need not be secured on bottom housing part 2 with additional mechanical fasteners.

According to FIG. 3(b) web 15 is in contact with outer projection 10 of top housing part 3 when housing 1 is closed. However, housing 1 in FIGS. 4(a) and (b) has its parts deformed, i.e., the wall of bottom housing part 3 is collapsing inward. As shown in FIG. 4(b), however, web 15 need not necessarily be in contact with inner projection 10 to achieve a good sealing effect. Instead, sealing device 4 has a good sealing effect even when web 15 and outer projection 10 have a tolerance Δl relative to one another. Maximum allowed tolerance Δl is determined from width D of groove 13 and the maximum compressibility of sealing element 17 in the area of first leg 18. It is thus possible to produce a housing 1 having a relatively large tolerance Δl in the area of sealing device 4 without having any mentionable impairment of the sealing effect.

It should be pointed out here that due to the groove-and-web design, the contours of top housing part 3 conform obligatorily to bottom housing part 2, so that distortion of the housing may be compensated. In particular, a torque M occurs in distortion of a part of the housing, acting against sealing forces FD and thus improving the sealing effect.

As already mentioned, the accuracy of the shape of the housing is not particularly relevant in the present invention. Instead, according to FIG. 5, housing parts 2, 3 need not necessarily be in direct contact with one another. There may instead be a gap 21 between these housing parts 2, 3 through which a pressure, e.g., a water pressure or a gas pressure (arrows), may act on the top side of free leg 18. Therefore, tips 18′, 18″ of free leg 18 are pressed even more against the particular surfaces of middle projection 11 and web 15.

FIGS. 6 and 7 show two other exemplary embodiments of the sealing device according to the present invention.

In FIG. 6 as well as in FIG. 7, projections 10, 12, grooves 13, 14 and web 15 are arranged in mirror inversion, i.e., web 15 and projection 10 forming groove 13 face the inside of the housing while the other groove 14 and projection 12 are situated on the outside. First leg 18 in FIG. 6 is not designed to have a wedge shape. Instead, free leg 18 here merely has a tip 18′ which faces in the direction of the inside of the housing and comes to rest against web 15 on insertion of the two housing parts 2, 3. As in FIGS. 3 through 5, the sealing forces here are created by bending over tip 18′ and by compressing first leg 18.

FIG. 6 also shows a contact area 22 from which web 15 projects, this area being provided on the free end of bottom housing part 2. When closed, base part 20 of sealing element 17 comes to rest against this contact area 22. Therefore, in particular due to an additional sealing force acting parallel to the direction of joining and against contact area 22, the sealing effect may be further improved.

The sealing device in FIG. 7 has the following difference in comparison with that in FIGS. 3 through 5: top housing part 3 has only two projections 10, 11 facing bottom housing part 2. No outer projection and thus no second groove to accommodate second leg 19 are provided here. Second leg 19 is shaped here with rounded outer edges. Second leg 19 is inserted into a recess 23 in top housing part 3 and projects out of the outside contour of housing 1 so that it is additionally able to function as a shock absorber. Otherwise the sealing effect and the assembly of sealing element 17 correspond to those in the first exemplary embodiment according to FIG. 3.

Although in all the exemplary embodiments, U-shaped sealing element 17 is situated so that both legs 18, 19 point toward top housing part 3, it is naturally also possible for the arrangement of legs 18, 19 as well as grooves 13, 14 and web 15 to be designed in the opposite way.

FIG. 8 schematically shows the distribution of sealing forces FD on a rectangular housing having a sealing device of the type defined in the preamble (German Utility Model 1 773 961) and a sealing device according to the present invention. With the sealing device according to the related art, the housing walls are bent greatly inward due to the action of sealing forces FD, with sealing force FD decreasing in the middle of a wall relative to its ends, or in the extreme case, there being no sealing force at all. On the other hand, in the case of a sealing device according to the present invention (FIG. 8(b)), the absolute value of the sealing forces FD is the same on all sections of the housing. The walls of the housing are not deformed here because the housing parts are held in a proper shape by groove 13, web 15 and sealing element 17 situated between them.

The sealing device according to the present invention also has the following advantages:

The assembly forces in joining the parts are very minor for all exemplary embodiments. Therefore, it is possible to do without assembly devices and/or assembly aids for the most part.

In addition, the gasket and/or the sealing element does not roll and thus does not create any opening tendency or contaminated joints.

Furthermore, no groove facing the direction of shaping is required for assembly, so that no expensive displacement tools are needed in the case of plastic parts.

The seal is pressed into a groove in the housing with one flank and is thus secured well and assembled easily.

It is also possible to manufacture the sealing element for highly complex contours of the housing parts.

The sealing element is also suitable for moving parts such as battery covers.

The sealing element thus combines all the advantages of the types of seal mentioned in the preamble while also offering the possibility of manufacturing the housing in a stress-free manner and with broad tolerances, with additional advantages for a plastic housing in particular.

The present invention is suitable for all housings for accommodating measuring instruments in particular. However, the present invention is not limited exclusively to such a housing but instead may be expanded within the scope of the present invention to include housings for accommodating any devices.

In summary, it may be concluded that through the use of a sealing element which seals at least in part by compression in a groove in joining, it is possible to implement a sealing device which provides a good seal at any time and for all applications in a very simple but nevertheless very effective manner without the need to accept the disadvantages of the known generic sealing device.

The present invention is not limited exclusively to the exemplary embodiments of FIGS. 2 through 7. Instead, the present invention may be implemented in a variety of embodiments and modifications within the scope of the actions and abilities of those skilled in the art.

List of Reference Notation

1 housing

2 first housing part, bottom housing part

3 second housing part, top housing part

4 sealing device

5 receptacle device

6 circuit board

10-12 projections

13, 14 groove

15 web

16 sealing gap

17 sealing element

18, 19 leg

18 ′, 18″ tips of the leg

20 base part

21 gap

22 contact area

23 recess

A sealing device

B sealing element

C, D housing parts

E sealing leg

d width of the groove

FD sealing forces

)l tolerance

M torque

X joining direction

What is claimed is:

1. A sealing device for sealing a housing (1), comprising a first housing part (3) having at least one groove (13) and comprising a second housing part (2) having at least one web (15), the web (15) and the groove (13) engaging into one another to form a sealing gap (16) when the housing (1) is closed, wherein at least one sealing element (17) is provided, this element being shaped so that it is insertable into the sealing gap (16) and is elastically compressible there essentially at a right angle to the joining direction on insertion of the web (15) into the groove (13).

2. The sealing device as recited in claim 1,
wherein the sealing element (17) has a first leg (18) which is situated in the sealing gap (16) when the two housing parts (2, 3) are closed, so that it is possible to bring the first leg into contact with an outside surface of the web (15) in the sealing gap (16) along at least a portion of its outside surface, thus generating a sealing force (FD) which is essentially perpendicular to the outside surface of the web (15).

3. The sealing device as recited in claim 2,
wherein the first leg (18) tapers conically toward its free end, forming a tip (18′).

4. The sealing device as recited in claim 2,
wherein the first leg (18) is designed to have a wedge shape or a triangular shape toward its free end.

5. The sealing device as recited in one of the preceding claims, wherein the sealing element (17) has a contact part (18) which is in sealing contact with the first and/or second housing parts (2, 3) when the housing (1) is closed.

6. The sealing device as recited in one of the preceding claims, wherein the contour of the housing part (2) having the web (15) is not aligned with the contour of the groove (14).

7. The sealing device as recited in one of the preceding claims, wherein the housing part (2) having the web (15) is designed as a tubing.

8. The sealing device as recited in one of the preceding claims, wherein the sealing element (17) has at least one additional leg (19), and at least one housing part (2) has an additional groove (14) to accommodate the additional leg (19).

9. The sealing device as recited in claim 8,
wherein the housing part (3) having the additional groove (14) and/or the sealing element (17) is/are designed to have an essentially U-shaped cross section.

10. The sealing device as recited in claim 8 or 9,
wherein the first leg (18) has a smaller length in the stress-free condition than the other leg (19) which points outward.

11. The sealing device as recited in one of claims 8 through 10, wherein the additional leg (19) and the additional groove (14) are designed to have an essentially rectangular cross section, the additional leg (19) being insertable into the additional groove (14) with an accurate fit.

12. The sealing device as recited in one of the preceding claims,
wherein the two housing parts (2, 3) completely accommodate the sealing element (17) when closed.

13. The sealing device as recited in one of claims 8 through 12, wherein the sealing element (17) is insertable into the housing (1) in such a way that an exposed outside surface of the additional leg (19) projects above an outside surface of the housing (1).

14. The sealing device as recited in claim 13,
wherein the exposed outside surface of the additional leg (19) has rounded edges.

15. The sealing device as recited in one of the preceding claims,
wherein the sealing element (17) is supported as a floating element so that it is not attached to any housing part (2, 3).

16. The housing as recited in one of the preceding claims,
wherein the sealing element (17) is made at least in part of an elastic material.

17. The sealing device as recited in one of the preceding claims,
wherein the sealing element (17) contains a plastic, in particular an elastomer or a natural rubber.

18. The sealing device as recited in one of the preceding claims,
wherein the sealing element (17) contains at least one reinforcing element.

19. The sealing device as recited in one of the preceding claims,
wherein one housing part (2, 3) has a greater rigidity than the other housing part (2, 3).
